(19) United States
(12) Patent Application Publication
(10) Pub. No.: US 2010/0140116 A1
(43) Pub. Date: Jun. 10, 2010

(54) RESEALABLE CONTAINER FOR STORING MOISTURE SENSITIVE TEST ELEMENTS

(76) Inventors: Matthias Stiene, Munchen (DE); Eurig Wyn Jones, Munchen (DE)

Correspondence Address: MORGAN LEWIS & BOCKIUS LLP, 1111 PENNSYLVANIA AVENUE NW, WASHINGTON, DC, 20004, US

(21) Appl. No.: 12/523,020

(22) PCT Filed: Jan. 29, 2008
(86) PCT No.: PCT/EP2008/000679

§ 371 Date: Jan. 7, 2010

(30) Foreign Application Priority Data
Jan. 29, 2007 (EP) PCT EP2007 000753

(51) Int. Cl. B65D 81/26; B65D 85/00; B23P 19/04

(52) U.S. Cl. 206/204; 206/459.1; 29/700

(57) ABSTRACT

A container for moisture sensitive test elements comprising a container body (2, 102, 202), an insert (22, 122, 220) fitting in container body, whereby a cavity (18, 118) is created between outer surface of insert wall (24, 124, 240) and inner surface of container body wall (4, 104, 204), and a lid (50, 150, 250) dimensioned to seal container open end when in a closed position, wherein a desiccant material is contained within the cavity (18, 118) between container body wall and insert wall. Insert wall defines a hollow channel (29, 129, 229) which is dimensioned that at least one test element ex-tents from the insert channel facilitating accessibility to an individual test element for the testing of an analyte of interest. Desiccant material includes an indicator whose colour changes when exposed to moisture indicating to a user whether contents therein, i.e. test elements, have been compromised by environmental factors.

### FIELD OF THE INVENTION

The present invention relates to a resealable container. More particularly, the present invention relates to a resealable container for storing moisture sensitive test elements, e. g. test elements for testing analytes such as glucose in bodily fluids.

### BACKGROUND OF THE INVENTION

The use of devices at the point of care has become increasingly common and prevalent over the last few years with the development of electronic miniaturization techniques, improved test element technology, and the increasing number of individuals eager to self-manage their diseases.

One disease which is becoming common in the western world is diabetes mellitus. Diabetes mellitus is a disease characterised by persistent hyperglycemia, resulting either from inadequate secretion of the hormone insulin, an inadequate response of target cells to insulin, or a combination of these factors. In 2006, according to the World Health Organization, at least 171 million people worldwide suffer from diabetes. Its incidence is increasing rapidly, and it is estimated that by the year 2030, this number will double.

Diabetes mellitus affects people of all ages and currently no known cure exists. People suffering from such a chronic disease are recommended by a Health Care Professional (HCP) to establish their blood glucose concentrations, often several times per day, to minimize the long term complications emanating from such a disease. For example, the impact of uncontrolled or erratic blood glucose levels can lead to a high risk of other diseases occurring, such as kidney failure, sight impairment, and nerve damage.

Measuring the glucose concentration in samples of physiological fluid is a particularly common task. Generally, such a task is performed by means of a diagnostic kit. The kit may typically include a lancing device, lancets, a container containing test elements, and of course a portable diagnostic device.

Performing a diagnostic test usually involves a user removing a test element from a vial or container, inserting the test element into the portable diagnostic device, pricking of a finger with the lancing device, and subsequently applying a physiological sample fluid e.g. capillary blood, onto an application area of the test element. Evaluation of an analyte concentration is performed and the user notified of the result after a few moments. Spent test elements are removed from the diagnostic device and appropriately disposed.

Furthermore, patients who diligently and conscientiously follow HCP guidelines in performing regular glucose measurements are generally at risk of developing calluses and/or blisters at the lance point i.e. finger tips. Such conditions generally cause patients great discomfort and in extreme cases a loss of finger tip sensation, thus reducing the likelihood of efficient removal of test elements from currently known vials or containers. Additionally, such a loss of sensation increases the risk of the patient of spilling the entire contents of the vial or container during intended removal of a single test element, thus leading to a potential contamination of each test element.

Even so, patients unaffected by calluses and/or blisters are equally challenged in efficient removal of test elements due to the dimensional limitations of both test elements and containers. Of course, such problems are exasperated for sight impaired patients, an impairment being a particular consequence of diabetes mellitus, resulting in intended removal of a single test element from a container being extremely problematic.

Another problem is the protection of the moisture sensitive test elements from environmental factors, above all from moisture absorption. Absorption of moisture by the test elements can lead to a falsification of the test results and can therefore make the test elements useless.

Vials or containers for protecting articles from environmental factors have long been considered an important area of research, and as an example U.S. Pat. No. 3,826,358 published to Butler et al., on July 30, 1974 discloses a tubular container having inwardly projecting holding means and cushion means frictionally engaged therewith adjacent a bottom end wall. Furthermore, an ambient effective insert may be retained between the cushion means and the bottom end wall. Such a container is for the containment of tablets.

U.S. Pat. No. 5,114,003 (Expired) published to Jackisch et al., on May 19, 1992 discloses a desiccant canister which is filled with fresh desiccant and immediately sealed against moisture. The sealed canister is placed in the base of a tablet container. Immediately before the tablets are placed in the container the desiccant canister is punctured to expose the desiccant to the air in the container. Tablets are then placed in the container and the container is sealed against the ambient air.

U.S. Pat. No. 3,254,784 published to Lancesseur on June 7, 1966 discloses a closure for a bottle, which comprises a disc-like base portion and a skirt defining a cavity with a body of dehydrating material received in the cavity.

U.S. Pat. No. 4,834,234 published to Sacherer et al., on May 30, 1989 discloses a container for test elements for the analysis of body fluids. Such a container comprises a container body with a circular removal opening, a sealing surface facing the axis of the opening and a stopper for the closure of the removal opening. The stopper has a cover plate, a hollow plug attached thereto with an outwardly facing sealing beading, a drying agent cell within the hollow plug and a support insert by means of which the hollow plug is supported on its inner side. Clearly, test elements are loosely contained within the container, making removal of a single test element an arduous task to all but dexterous individuals.

U.S. Pat. No. 5,911,3937 published to Hekal on June 15, 1999 discloses a desiccant entrained polymer having a polymer matrix within which a desiccant agent is entrained in the structure of the product itself or in an appropriate insert.

Furthermore, several attempts have been made over the years to address the issue of easier handling of test elements contained within a container. For example, United States Patent Application 2004/0007585 and published to Griffith et al., on Jan. 15, 2004 discloses a test element container for storing and dispensing test elements having a container configured to store a stack of test elements and to dispense the test elements from the container one at a time. A biasing means is additionally included for biasing the stack of test elements to facilitate one-by-one dispensing. Such biasing pushes the stack of test elements in a horizontal upwards movement towards an opening, that is, in a movement which is parallel to a base.

However, such a construction of a container relies on mechanical components for user removal of a test element which are susceptible to malfunctions. Moreover, manufacture of such containers is somewhat expensive.

Thus, it is an object of the present invention to provide a container which simplifies user removal of a test element therefrom and which is simple in design and inexpensive to manufacture.

It is another object of the present invention to provide a container having hygroscopic properties such that contained test elements are protected from environmental factors such as moisture.

### SUMMARY OF THE INVENTION

The above identified objects are solved by a container for moisture sensitive test elements according to claim 1, comprising a container body, an insert fitting in container body and being dimensioned that a cavity is created between outer surface of insert wall and inner surface of container wall, and a lid dimensioned to seal container open end when in a closed position, wherein a desiccant material is contained within the cavity between container body and insert.

The inventive container is constructed in such a manner that removal of a test element therefrom is simplified. Therefore, insert, having a rectangular hollow channel, is dimensioned to receive a stack of test elements oriented in an upright formation. Preferably, hollow channel is dimensioned that at least one test element extends from the insert channel facilitating accessibility to an individual test element when lid is in open position.

In a preferred embodiment of the invention, the container is designed that it is indicated to a user whether contents therein, i.e. test elements, have been compromised by environmental factors. Therefore, desiccant material contained in the container cavity preferably includes an indicator whose colour changes when exposed to moisture, and container body preferably comprises a transparent wall whereas insert wall preferably is opaque.

The preferably cylindrical container for the containment of diagnostic test elements is simple in design and inexpensive in manufacture.

The inventive container containing the test elements may be used in a point of care and home setting. Such test elements may be used for determining the concentration of glucose in a small sample of physiological fluid and/or for determining the coagulation properties in a small sample of blood and/or for evaluating an affinity reaction between an analyte of interest and a recognition element.

### BRIEF DESCRIPTION OF DRAWINGS

A better understanding of the features and advantages of the present invention will be obtained by the following detailed description that sets forth illustrative embodiments by way of example only, with reference to the accompanying drawings of which:

FIG. 1 shows a simplified perspective view of a container according the present invention having a lid in a sealed position;

FIG. 2 shows the container body having a discontinuity in the container wall according to an embodiment of the present invention;

FIG. 3 shows a perspective view of an insert according to an embodiment of the present invention;

FIG. 4 shows a perspective view of insert disposed within container body having a lid in an open position;

FIG. 5 shows a cut-away view of the lid according to an embodiment of the present invention;

FIG. 6 shows a cross-sectional view along line A-A′ of FIG. 1 with an insert having integral lid in a closed position and disposed within container body according to an embodiment of the present invention;

FIG. 7 shows a cross-sectional view along line of A-A′ of FIG. 1 with an insert disposed within container body, and having a lid in an open position according to an other embodiment of the present invention;

FIG. 8 shows an exploded view of FIG. 7 depicting a hollow space between inner surface of container wall and outer surface of insert, and a retaining element integral with a lid;

FIG. 9 shows a perspective view of a retaining element integral with a lid;

FIG. 10 shows a perspective view of an insert having an integral lid according to an other embodiment of the present invention;

FIG. 11 shows a perspective view of an insert according to FIG. 10 disposed in a container body with lid in an open position;

FIG. 12 shows a simplified cross-sectional view along line A-A′ of FIG. 1 with a stack of test elements contained within container and a lid in a closed, sealing position;

FIG. 13 shows a simplified perspective view of a container, again with a lid removed for the purposes of clarity, and a stack of elements inserted into the test element channel according to embodiments of the present invention;

FIG. 14 shows the container of FIG. 11 grasped in a user's hand, with a user removing a single strip therefrom according to embodiments of the present invention.

### DETAILED DESCRIPTION OF THE INVENTION

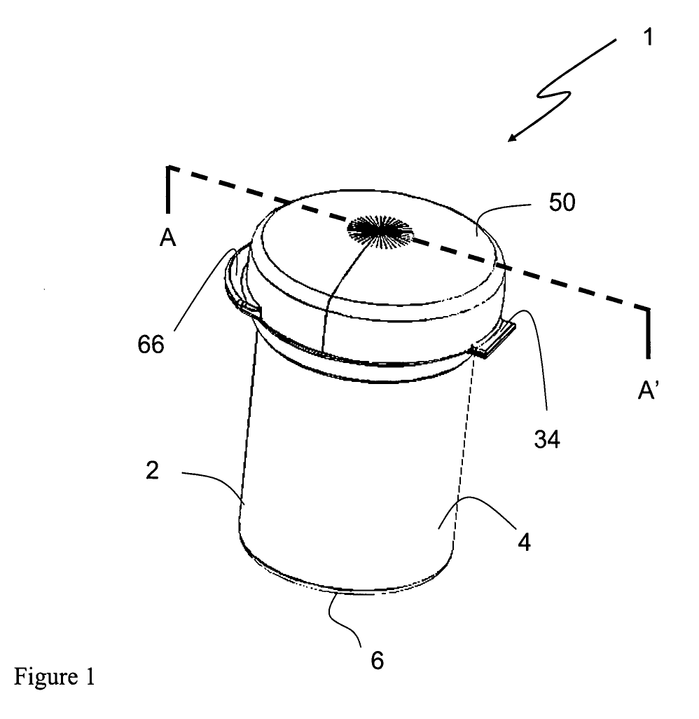

In FIG. 1, a simplified perspective view of a container 1 is shown for the containment of test elements. The container is configured in a substantially cylindrical shape, and dimensioned such that it can be held in the palm of one hand. The container comprises integrally formed walls 4 which define a container body 2 with a container bottom 6 and an upper open end (not shown). Also depicted is a container lid 50, shown in the current figure as being in a sealed (i.e. closed) position. Container lid 50 is connected, as will be described later, to a disposed inner part of container by means of a resilient hinge 34. A free end of the container lid 50 i.e. being opposite the hinge 34 end, comprises a tab 66. Tab 66 allows for easier movement of the lid 50 to/from its sealing position.

Container lid 50 preferably provides a resealable airtight seal when lid 50 is in a closed position to protect against harmful effects of the environment and preventing the spoilage of test element(s) contained within the container. When container lid 50 is in an open position, an opening is created between container body and container lid 50 for allowing a test element to be dispensed therethrough (as is described in further detail below).

Although, for the purpose of explanation only, container body is illustrated as essentially an open-ended cylindrical container, resealable containers according to embodiments of the present invention can have any suitable shape.

Container preferably is manufactured from a high strength material such as polypropylene or any other liquid impervious plastic material, providing sufficient rigidity for container to retain its shape when manipulated by a user. Preferably, container wall is transparent or semi-transparent. Optionally, outer surface of container may be knurled for allowing easier user handling. Indeed, such knurling may additionally provide a registration feature for use by a machine during filling with test elements.

Container 1 may additionally include a sticker or a label (not shown) for displaying information related to the test elements stored therein. For example, the label may display commercial information identifying the source of the test elements and/or coded information in the form of a bar code and/or a data matrix code. The bar code and/or data matrix code may contain information identifying properties of the test elements, such as the batch code for the test elements, the date of expiration of the test elements, the initial number of test elements stored in a fully loaded container, and so on. As will become apparent later, sticker or label may be disposed elsewhere about container.

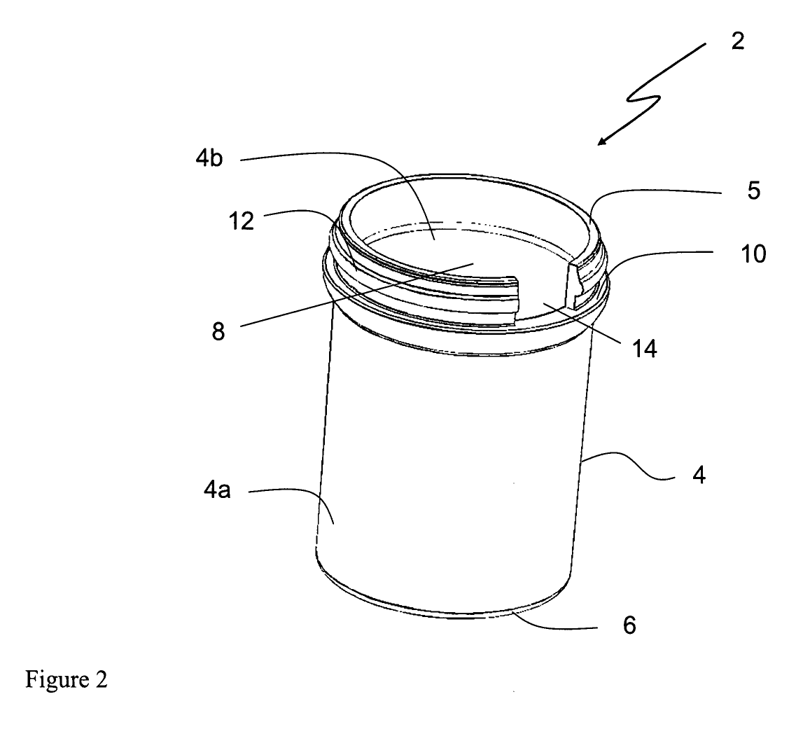

FIG. 2 shows a perspective view of the container body 2. As discussed previously, container body 2 is cylindrically shaped having a side wall 4 having an outer surface 4a and a parallel inner surface 4b. Cylindrical shaped container body 2 has an open-end 8 and a closed-end, which preferably is integrally formed with side wall 4 forming a bottom 6. Indeed, it is envisaged that bottom 6 of container body 2 may be attached to side wall of container body 2 by welding, screwing, and/or adhesive bonding. Open end 8 of container body 2 allows, as will be explained in detail later, test elements to be inserted and/or removed from container 1. Upper end of container body 2 is formed by a discontinuous rim 5.

Container body 2, as shown, additionally includes a perpendicularly arranged container body counterface 10 provided near the open end 8 of container body 2. Counterface 10 forms a region for interfacing with a region of lid 50 as will be discussed later. Container wall 4 perpendicularly extends beyond counterface 10 and has a discontinuous region 14. Discontinuous region 14 is provided, as will be described later, for interfitting with a region of an insert and/or retaining element. Further shown in the current figure is a semi-continuous collar 12. Semi-continuous collar 12 is for interfacing with a region on lid 50 as will become apparent later.

Preferably, container side wall 4 and/or container bottom 6 are transparent or semi-transparent.

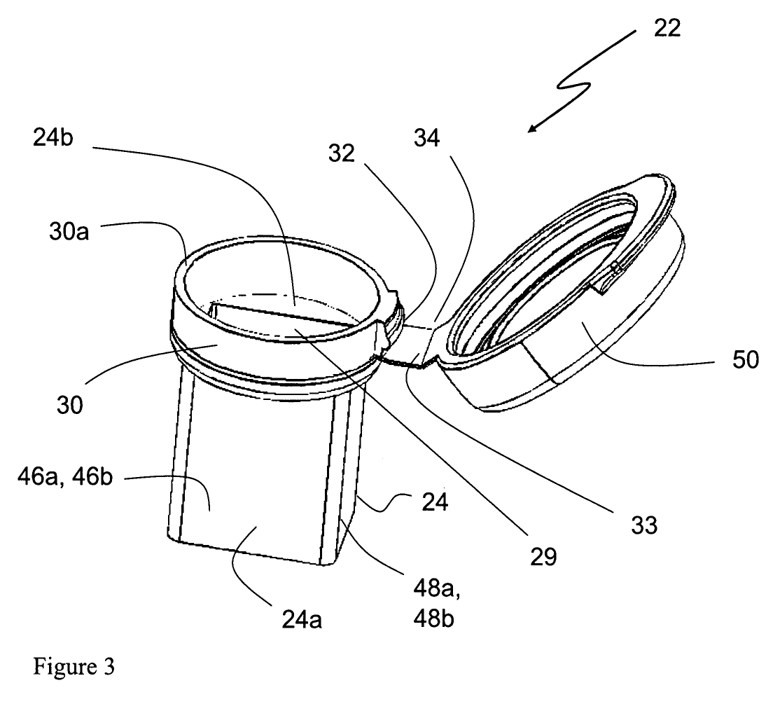

FIG. 3 shows a perspective view of an insert 22. Insert 22 comprises an insert wall 24 having an outer surface 24a and a substantially parallel inner surface 24b. Insert wall 24 defines a centrically arranged, preferably rectangular longitudinal channel 29. Due to its rectangular cross-sectional configuration, the channel 29 defines an opposed pair of longitudinal sides 46a, 46b and an opposed pair of lateral sides 48a, 48b. Rectangular channel 29 is sized and dimensioned for the containment of a stack of test elements, such that individual test elements from the stack can easily be removed therefrom as will be discussed later. Dimensions of channel 29 can be varied to suit one's needs. For example, opposed pair of longitudinal sides and opposed pair of lateral sides have a length of about of 35 mm.

A peripheral annular wall 30, provided to abut inner surface of container body wall 4, perpendicularly extends beyond insert wall 24. Disposed on an outer surface of annular wall 30 is a ridge 32. Ridge 32 is provided to align with discontinuous region 14 of container wall (see FIG. 2), and furthermore with semi-continuous collar 12 of container wall as will be shown later. Ridge 32 of the insert 22 and collar 12 of container body 2 are for interfacing with a region of lid 50 as will be discussed later.

Optionally, an inner surface of annular wall 30 may further include an inwardly arranged annular recess (not shown). Such annular recess is intended to provide a region for a locking and sealing arrangement with a corresponding collar on the lid 50. In a preferred embodiment however, region for locking and sealing with a corresponding part on lid 50 is provided by means of a ridge/collar 32, 12 arrangement as shown.

Included as part of annular wall 30 outer surface is a flange 33. Flange 33 is essentially arranged to project between discontinuous region 14 of container wall (see FIG. 2), having a width being generally the same as the width of container wall discontinuous region 14. Flange 33 is provided to form a contiguous surface or semi-contiguous surface with container wall counterface.

Furthermore, and included as part of projecting flange 33 is a resilient hinge 34. Resilient hinge 34 is preferably disposed on an outer edge of projecting flange 33 and additionally connects to lid 50. Lid 50 provides a barrier against harmful effects of the environment when in a closed sealing position. It can therefore be seen that insert 22 and lid 50 preferably are moulded or co-moulded forming a one part piece. Upper end of insert annular wall 30 is formed by a rim 30a.

Insert 22 is dimensioned to fit within tubular container body 2. Circumferential upper end of insert wall 24 and optionally lower end of insert wall 24 may have a diameter slightly smaller than the internal diameter of container body 2 such that insert 22 may be held in place by a close fit, interference fit and/or welding.

Insert 22 preferably is opaque preventing the content, i.e. test elements, from harmful rays, e.g. UV light, and preferably is manufactured from a polymeric material such as polypropylene or other thermoplastic materials.

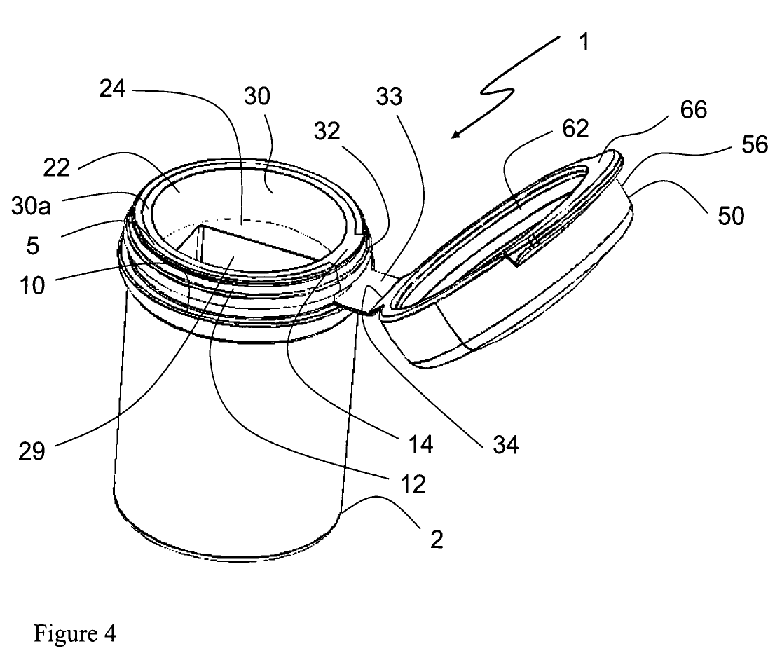

FIG. 4 is a perspective view of insert 22 disposed within container body 2 with lid 50 in an open position. The dimensions of the inner diameter of the container body 2 and outer diameter of insert wall 24 upper end (and optionally lower end) are regulated so that there is a sealing relationship between them at least over a portion of their concentricity, that is to say, the sealing relationship should be either that of an interference fit or of a close fit. As can be seen in FIG. 4, rim 30a of insert annular wall 30 forms a contiguous surface with rim 5 of container wall. Furthermore, outer dimensions of annular wall 30 are regulated so that there is a sealing relationship with inner dimension of container wall 4.

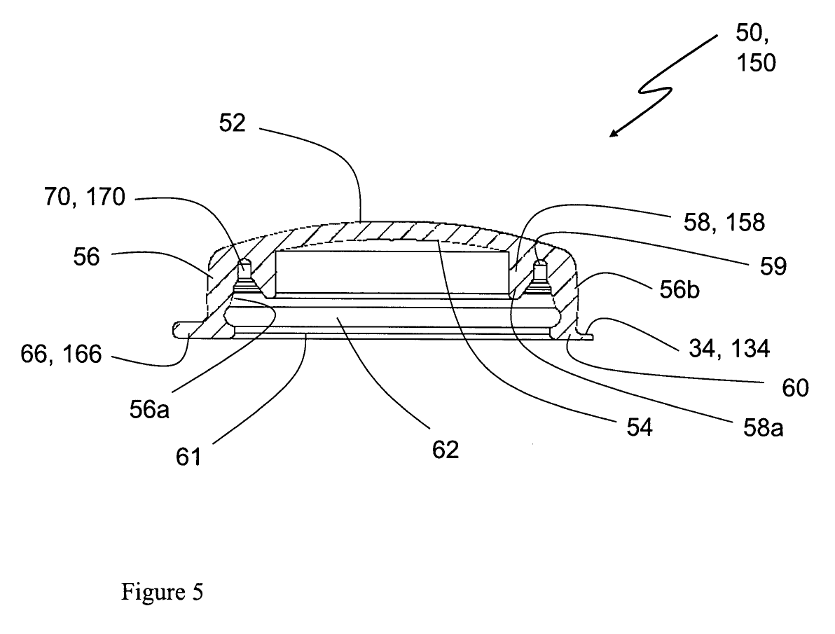

Outer surface of insert annular wall 30 includes flange 33 which peripherally projects between discontinuous region 14 of container wall. Flange 33 is dimensioned to fit between discontinuous region 14 of container wall 4, providing a semi-continuous counterface 10. Counterface 10 forms a region for the lid 50 to abut thereby providing sealing protection of the contents of the container against harmful effects of the environment. Outwardly arranged ridge 32, disposed on an outer surface of annular wall 30 of insert 22 is further arranged to fit between discontinuous region 14 of container upper body 2. Ridge 32 is laterally positioned at insert wall outer surface such that it is aligned with semi-continuous collar 12 of container body outer wall. Ridge 32 is of suitable dimension for sealingly receiving an annular recess 62 of lid 50 (see also FIG. 5). This recess 62 further serves as a means for preventing longitudinal and axial movement of lid 50 when in a closed position.

Further shown in FIG. 4 is lid 50 connected to projecting flange 33 by means of integral hinge 34. Hinge 34 is provided on an opposite side of beak shaped tab 66, which extends in a lateral direction from a lower edge of lid 50 outer wall 56.

Forming part of the disposed insert 22 is channel 29. Rectangular channel 29 is centrically arranged within insert 22 and dimensioned for the containment of a stack of test elements. For example, opening of the channel 29 has an opening length of about 21 mm and an opening width of about 14 mm.

FIG. 5 shows a cut-away view of the lid 50 according to an embodiment of the invention. Lid 50 being in the general shape of an outwardly convex cylindrical disk has a first surface 52 and a substantially parallel second surface 54. Cylindrical disk has a diameter equal to that of container body counterface 10 (see FIG. 4) disposed near the open end of container body 2.

Lid 50 includes a generally cylindrical, continuous sidewall 56 having an inner surface 56a and a parallel outer surface 56b. Thickness of lid wall 56 is generally equal to that of thickness of container body wall 4. Depth of lid wall 56, i.e. depth between second surface 54 of disk and a lower edge of lid wall 56 is generally equal to the height of wall 4 projecting above counterface 10 of container body 2 (see FIG. 2). Furthermore, inner surface 56a of lid wall 56 defines a diameter which is generally equal to the outer diameter of container wall 4. Preferably included on inner surface of lid wall 56, and disposed on a peripheral lower end, is an annular recess 62. Annular recess 62 has a diameter greater than inner diameter of wall 56 and configured to interlock with ridge 32 and collar 12 arranged at outer surface of insert 22 annular wall 30 and outer surface of container wall, respectively.

Additionally, lid 50 includes a skirt 58 connected to the planar disk at a shoulder 59 and is dimensioned to extend downwardly and coaxially from the second surface 54 of lid 50. Skirt 58 has an outer diameter smaller than the inner diameter of the lid 50 wall, such that an annular space 70 is provided between an outer surface of skirt and inner surface of lid wall 56a. Annular space 70 is provided to fit over container wall 4 projecting above container body counterface 10, when lid 50 is in a closed sealing position.

Lower end of skirt outer face 58a tapers inwardly, preferably at an angle of about 5°.

This feature provides ease of lid 50 closure and in particular of insertion into opening defined by insert annular wall 30 (see FIG. 3). Skirt 58 fits into open end of insert 22 to which the lid 50 has been hingably secured to seal the contents of insert 22 when the lid 50 is pivoted toward its closed position. In particular, lid recess 62 is provided to interlock with ridge 32 of insert and henceforth semi-continuous collar 12 of container wall 4 when lid 50 is in a closed position, as will become apparent later.

Furthermore lid 50 comprises an opening 61 which extends from a lower end of the skirt 58 up to second surface 54 of lid, thus defining a hollow portion. Hollow portion is configured to contain an upper end of stack of test elements, as will become apparent in later figures.

Lid 50 preferably includes a beak-shaped tab 66 extension, which extends in a lateral direction from lower edge of wall 56, to assist a user in the opening and/or closing of lid 50. Hinge 34 included on an opposite side of the tab 66, securely forms part of insert projecting flange 33 as discussed. Hinge 34 provides for a selected displacement of lid 50 to/from a sealing position during user interaction of beak-shaped tab 66.

Lid 50 is of unitary construction and preferably is injection moulded or co-moulded of a suitable synthetic resin with insert 22. Lid 50, moulded or co-moulded with insert, is opaque in nature thus impeding harmful rays (e.g. UV fraction of day light) from entering the container, when lid 50 is in a sealingly closed position.

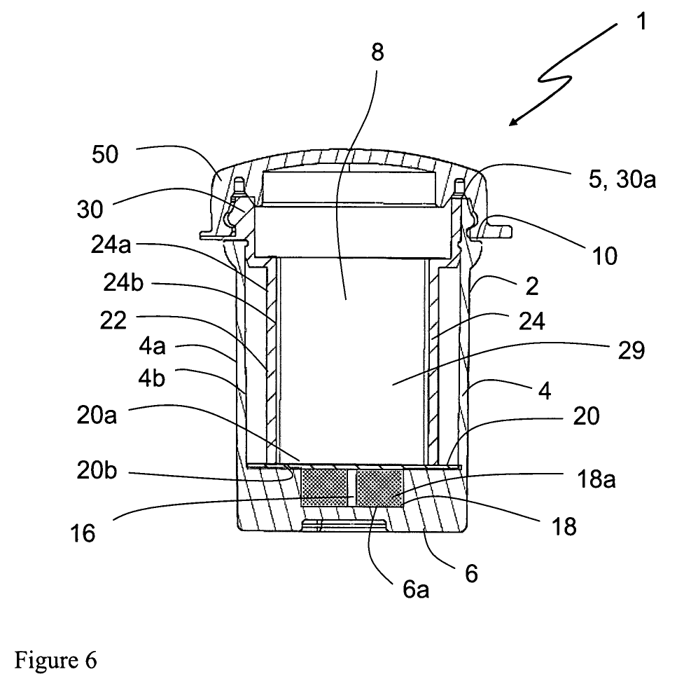

FIG. 6 shows a cross-sectional view along line A-A′ of FIG. 1 having an insert 22 disposed in container body 2 according to one embodiment of the present invention. Lid 50, integral with insert 22, is in a closed sealing position.

As discussed previously, container body 2 preferably is cylindrically shaped having a side wall 4 having an outer surface 4a, an inner surface 4b, an open-end 8 and a closed-end (bottom) 6.

Disposed within the container body 2 is insert 22. Insert 22 has an insert wall 24 having an outer surface 24a and an inner surface 24b and defines a centrically arranged rectangular longitudinal channel 29 which extends through the upper end 8 to the lower end 6 of container body 2. Upper end—and optionally lower end—of insert wall 24 may have a diameter slightly smaller than the internal diameter of container body 2 such that insert 22 may be held in place by a close fit, interference fit and/or welding.

The container for storing moisture sensitive test elements according to the present invention is characterized in that a cavity 18 is created between inner surface 4b of container wall 4 and outer surface 24a of insert wall 24 for the containment of a desiccant material 18a. In the embodiment of the inventive container according to FIG. 6, the cavity 18 is provided at the bottom 6 area of container body 2 between the inner surface 6a of container bottom 6 and a bottom 20 arranged at the lower end of insert wall 24.

In one embodiment of the present invention, insert 22 comprises a bottom 20 which is integrally formed with insert wall 24.

Preferably, as shown in FIG. 6, the bottom 20 of the insert 22 is formed by a “false” bottom. Furthermore and accordingly, lower end of insert wall 24 is arranged to abut first surface 20a of false bottom 20 as shown. Such an arrangement ensures that desiccant material 18a contained within cavity 18 may absorb moisture which may ingress into container body and in particular rectangular channel 29 during normal use of the container.

Preferably, inner surface 6a of container bottom 6 includes several support structures 16 which may be attached to or made integral with container bottom. Support structures 16 may be provided as arms which may radially extend from a central position to a perimeter of the inner surface of container bottom juxtaposing optionally integrally formed wall 4b of container body 2. Any number of support structures 16 may be attached or made integral with container bottom 6, thus being preferably separated equidistance from each other, so as to provide open spaces therebetween. The depth of the support structures 16, e.g. arms, depends on the volume of desiccant material 18a required in cavity 18. Preferably, support structures 16 are about 6 mm in depth.

Support structures 16, attached to or made integral with container bottom 6 provide a support for false bottom 20. False bottom 20, having an annular edge, a first side 20a and a second side 20b, is dimensioned to have a diameter generally equal to the inner diameter of container body 2. Such dimensional arrangements are regulated so that there is a sealing relationship between annular edge of false bottom 20 and inner wall of container body 2, that is to say, the sealing relationship is either that of an interference fit or of a close fit.

Thus, at least one hollow cavity 18 is provided between inner surface 6a of container bottom 6 and second side 20b of the insert bottom or false bottom 20. Cavity 18 is for the retention of the desiccant material 18a as previously described. Preferably, insert bottom or false bottom 20 is of a porous material which enables moisture or moisture contaminants to be absorbed by the desiccant material 18a contained in cavity 18. The material also serves as a strainer to prevent contents of the container (i.e. test elements) from becoming plugged by contamination from the desiccant material 18a. Alternatively, cavity 18 may be filled with material to protect the test elements from other environmental factors such as Oxygen, for example.

As mentioned, disposed between inner surface 6a of container bottom 6, e.g. between radially extending arms 16 and insert bottom or false bottom 20, is a layer of moisture absorbent desiccant material 18a. The layer of moisture absorbent desiccant material preferably has a thickness of approximately 5 mm. Such a material may be in particulate form such as granules or crystals of silica gel, or silica gel in pellet or powder form, silica aerogels, molecular sieves or any other hygroscopic material known to persons skilled in the art. It is envisaged that layer of desiccant material 18a is provided to absorb any moisture which may enter container during normal usage of the container i.e. during removal of a test element for instance.

Preferably, moisture absorbent desiccant material 18a contains an indicator whose colour changes when exposed to moisture. Such an indicator may be Cobalt Dichloride which may change from a blue colour in a non-moisture absorbent state, to a pink colour in a moisture absorbent state. Furthermore, rate of colour change of indicator material preferably is directly proportional to its exposure to moisture. Colour change is visible to a user by means of a transparent container wall 4 or a transparent section of container wall 4.

Although not shown in any of the figures, preferably provided between outer surface of insert wall 24a and inner surface of container wall 4b is a sleeve. It is envisaged that sleeve may be transparent and includes a sticker or printed information for displaying information related to the test elements stored within container. Furthermore, sticker or label may include a coloured reference scale for allowing a visual comparison to be made with moisture absorbent indicator. Preferably, coloured scale is adjacent to the absorbent material and indicator material. Label may additionally display commercial information identifying the source of the test elements, identifying properties of the test elements, the date of expiration of the test elements, the initial number of test elements stored in a fully loaded container, and so on.

Whilst the aforementioned insert is described herein as an insert disposed and retained within container body, it will become apparent through subsequent illustrations that container and insert could be moulded or co-moulded, forming a one part piece. It is also envisaged that insert first end may additionally include alphanumeric and/or non-alphanumeric markings, thus aiding a user in correctly identifying the contents of the container. Furthermore, insert first end may additionally include a graduated chromatic scale (e.g. colour or mono) aiding in the indication to a user of the quantity of test elements remaining within the container.

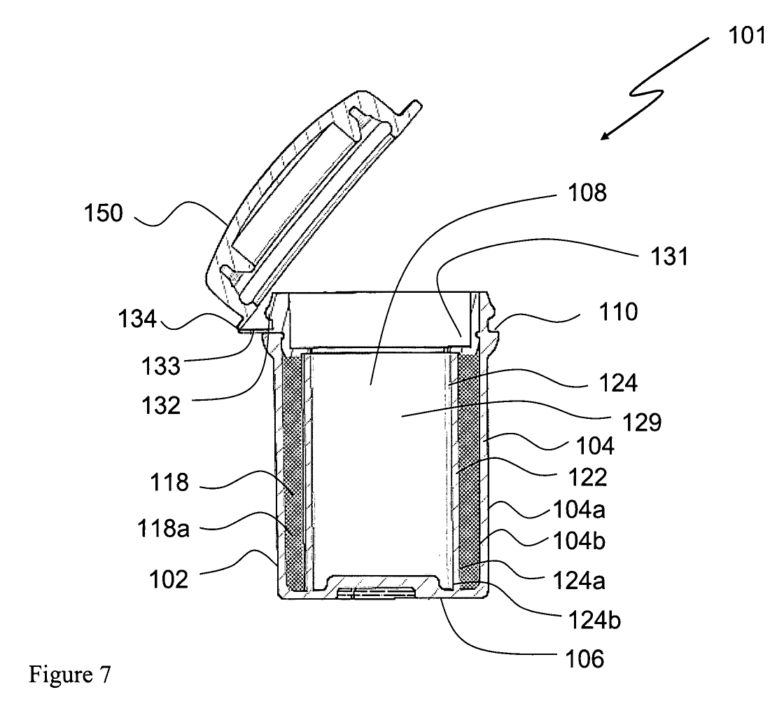

In FIG. 7 a cross-sectional view along line A-A′ of FIG. 1 is depicted according to an other embodiment of the invention. Lid 150 is in open position for the purposes of clarity.

Again, in the current embodiment, container body 102 preferably is transparent and cylindrically shaped having a side wall 104 having an outer surface 104a and an inner surface 104b. Cylindrical shaped container body 102 has a closed-end 106 and an open-end 108. Closed-end 106 is integrally formed with side wall forming a bottom 106 having an outer surface and an inner surface. Indeed, it is envisaged that bottom 106 of container body 102 may be attached to side wall 104 of container body 102 by welding, screwing, and/or adhesive bonding. Preferably, container bottom 106 also is transparent. Open end 108 of container body allows several parts i.e. such as an insert and a sleeve to be placed within the container body 102.

Inserted in the container body 102 is an insert 122. Insert 122, optionally manufactured from a polymeric material such as polypropylene and the like, is dimensioned to fit within tubular container body 102. Insert 122 comprises a centrically arranged wall 124 which defines a rectangular longitudinal channel 129 which extends vertically from first surface of container bottom 106 to near the open end of container 108 and has a rectangular opening arranged opposite container bottom 106.

Due to its rectangular cross-sectional configuration, the channel 129 defines an opposed pair of longitudinal sides and an opposed pair of lateral sides. Opposed pair of longitudinal sides and opposed pair of lateral sides may have a length of about of 35 mm. Rectangular channel 129 is sized and dimensioned for the containment of a stack of test elements, such that individual test elements from the stack can easily be removed therefrom. Dimensions of rectangular channel can be varied to suit one's needs.

Optionally, insert 122 may have a circumferential end having a diameter being slightly smaller than internal diameter of container body 102 such that insert 122 may be held in place by a close fit, interference fit and/or welding. Further, circumferential lower end of insert 122 may be arranged to abut first surface of container bottom 106. However, depending on the material used, insert 122 may be moulded or co-moulded with container body 102.

Between outer surface of insert wall 124a and inner surface of container body wall 104b there is provided a circumferential annular cavity 118. Within cavity 118 is provided a layer of moisture absorbent desiccant material 118a. Such material may be in particulate form such as granules or crystals of silica gel, or silica gel in pellet or powder form, silica aerogels, molecular sieves, or any other hygroscopic material known to persons skilled in the art. Moisture absorbent material 118a is preferably layered to extend the length of insert. It is envisaged that layer of desiccant material 118a is provided to absorb any moisture which may enter container during normal usage thereof i.e. during removal of a test element for instance.

Preferably, moisture absorbent desiccant material 118a contains an indicator whose colour changes when exposed to moisture. Such an indicator may be Cobalt Dichloride which may change from a blue colour in a non-moisture absorbent state, to a pink colour in a moisture absorbent state. Furthermore, rate of colour change of indicator material is directly proportional to its exposure to moisture.

Furthermore, insert 122 may be manufactured from a porous material enabling moisture or moisture contaminants to be absorbed by desiccant material 118a. The material may also serve as a strainer to prevent contents of the container (i.e. elements) from becoming plugged by contamination from the desiccant material. As mentioned, insert 122 is generally opaque.

Layer of absorbent material 118a may be preferably retained within hollow space 118 by a retaining element 131 having an outer diameter slightly smaller than internal diameter of container body 102, and an inner opening slightly larger than insert wall 124 such as that provided by a close fit, interference fit and/or welding. Retaining element 131 is preferably manufactured from a polymeric material such as polypropylene and the like, and generally is opaque. Optionally however, retaining element 131 may be of a porous material or moisture permeable material which enables moisture or moisture contaminants to be absorbed by the desiccant material.

Further provided although not shown in the current figure is a sleeve. Preferably, sleeve is made of a plastic material and formed as a tube such that it is disposed within hollow space i.e. between outer surface of insert wall and inner surface of container wall. It is envisaged that sleeve may be transparent and includes a sticker or printed information for displaying information related to the test elements stored within container. Furthermore, sleeve may include a coloured reference scale for allowing a visual comparison to be made with moisture absorbent indicator. Preferably, coloured scale is applied adjacent to the absorbent material. Label may additionally display commercial information identifying the source of the test elements, identifying properties of the test elements, the date of expiration of the test elements, the initial number of test elements stored in a fully loaded container, and so on.

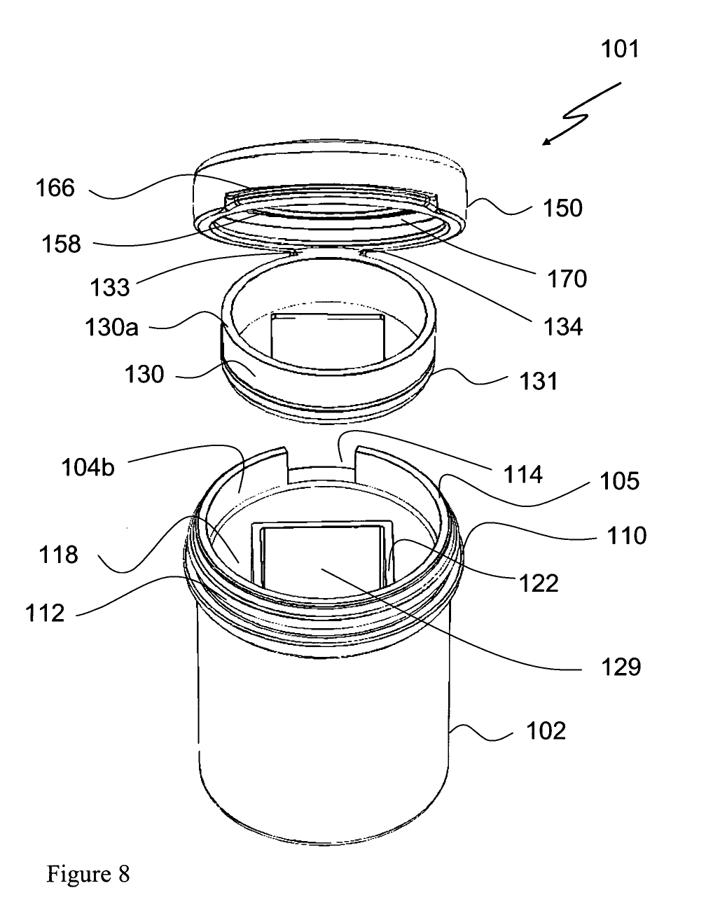

Referring to FIG. 8, an exploded perspective view of FIG. 7 is depicted showing insert 122 within container body 102. As previously discussed, forming part of the disposed insert is rectangular channel 129. Rectangular channel 129 is centrically arranged within insert 122 and dimensioned for the containment of a stack of test elements. Rectangular opening of channel 129 preferably has an opening length of about 21 mm and an opening width of about 14 mm. Circumferential lower end of channel 129 may be arranged as previously mentioned to abut first surface of container bottom 106. Again, length of channel 129 is such that upper end of test elements contained in the channel 129 projects above rim 105 of container body wall 104, as will become apparent from following Figures.

Annular hollow space 118 for containment of absorbent material 118a is also shown. Layer of absorbent material 118a is preferably contained by means of retaining element 131 as discussed. A peripheral annular wall 130 perpendicularly extending beyond retaining element 131 is arranged to abut inner surface of container wall 104b. Annular wall 130 has a suitable height not to exceed rim 105 of container wall 104, that is to say, rim 130a of annular wall is substantially contiguous with rim 105 of container wall 104 when container body 102 and retaining element 131 are assembled.

An outer surface of ring annular wall 130 includes a flange 133 and a resilient hinge 134. Resilient hinge 134 is preferably disposed on an outer edge of projecting flange 133 and additionally connects to lid 150. Lid 150 is for the containment of test elements, providing a barrier against harmful effects of the environment when in a closed sealing position. It can therefore be seen that annular retaining element 131 and lid 150 preferably are moulded or co-moulded forming a one part piece.

Skirt 158, connected to planar surface of lid 150 at shoulder, is constructed to extend downwardly therefrom and has a length determined by the length of annular wall 130 of retaining element 131. Lower end of skirt 158 tapers inwardly to ensure ease of lid 150 fitment into container body 102. Annular space 170, provided between inner surface of lid 150 wall and outer surface of skirt 158, is for fitting over container wall projecting above container body counterface 110.

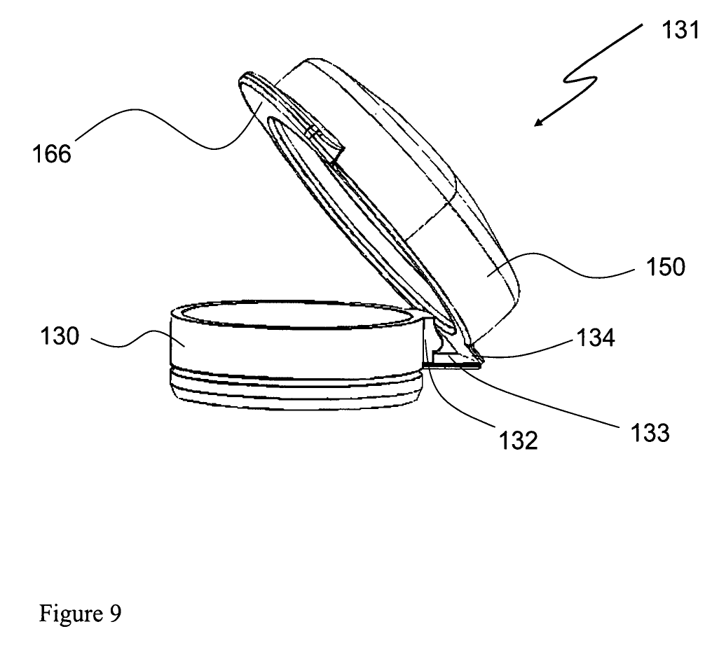

FIG. 9 is a further perspective view of the retaining element 131 integral with lid 150 depicting a ridge 132 disposed on an outer surface of annular wall 130. When container body 102 and retaining element 131 integral with lid 150 are assembled, ridge 132, provided at open end, is essentially aligned with discontinuous region 114 of container wall and semi-continuous collar 112 of container body 102. Ridge 132 and collar 112 of container body 102 (see FIG. 8) form a region for interfacing with a region of lid 150.

Lid 150 additionally includes a beak shaped tab 166 extending laterally from lower edge of lid 150, and arranged on an opposite side of hinge 134.

Optionally, inner surface of annular wall 130 of retaining element 131 may include an annular recess (not shown). Annular recess may be positioned mid-way between first end of insert and rim of container wall, and is for a locking engagement with an annular collar optionally disposed on lid 150.

As a matter of cause, the inventive container may be a combination of the embodiments according to FIG. 6 and FIGS. 7, 8 and 9, respectively. In this embodiment, the container may comprise cavities 18, 118 for the containment of desiccant material 18a, 118a both in the bottom area, i.e. between inner surface 6a, 106a of container bottom wall 6, 106, and in the annular circumferential area, i.e. between inner surface 4b, 104b of container body wall 4, 104 and outer surface 24a, 124a of insert wall 24, 124 of the container.

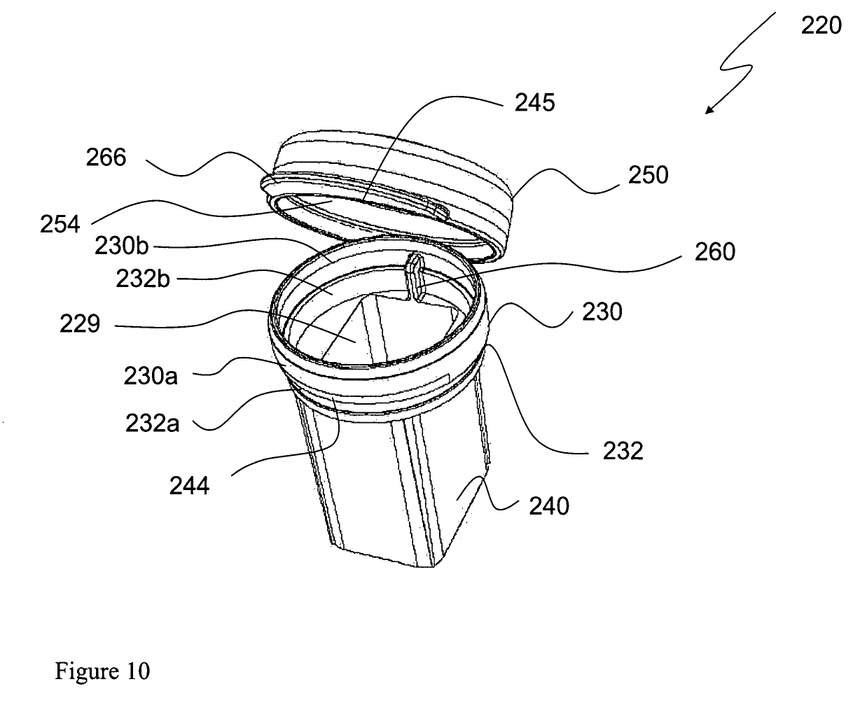

FIG. 10 shows a perspective view of an insert having an integral lid according to another embodiment of the present invention. In FIG. 10, a perspective view of insert 220 is shown with an integral lid 250 in an open position. Insert 220 has upper and lower concentrically arranged open annular walls 230, 232 which preferably are co-moulded forming a one part piece. Each annular wall 230, 232 has an outer surface 230a, 232a and an inner surface 230b, 232b. Outer diameter of upper annular wall 230 is greater than outer diameter of lower annular wall 232 and as will be shown in the subsequent figure, such a configuration limits the insertion of the insert 220 into open end of container body. Further, outer diameter of lower annular wall 232 is dimensioned to be of the same order as the inner diameter of container body and as such forms a tight fit when insert is inserted into open end of container body.

Insert 220 further includes an insert wall 240 which downwardly and insetly depends from lower insert annular wall 232. Insert wall 240 has an outer surface and a substantially parallel inner surface and defines a centrically arranged, preferably rectangular longitudinal channel 229. Rectangular channel 229 is sized and dimensioned for the containment of a stack of test elements, such that individual test elements from the stack can easily be removed therefrom as will be discussed later. Preferably length of longitudinal channel is dimensioned to be less than length of test element(s) to aid in removal thereof during use.

In this embodiment, an upstanding protrusion 260 is also provided forming part of inner surface 230b, 232b of lower and upper annular insert wall 230, 232. Upstanding protrusion 260 preferably forms a contiguous surface with inner surface of insert wall 240 to aid in the correct positioning of the test elements when contained within rectangular longitudinal channel 229.

Lid 250 is in the general shape of a cylindrical disk 254 having a first surface and a substantially parallel second surface and includes a generally cylindrical, continuous sidewall having an inner surface and a substantially parallel outer surface depending from cylindrical disk 254. Thickness of lid wall is generally equal to that of thickness of container body wall. Depth of lid wall, i.e. depth between second surface of disk and a lower edge of lid wall is generally equal to the height of upper insert annular wall 230. Furthermore, inner diameter of lid is generally equal to the outer diameter of upper insert annular wall 230, so that when lid is in a closed position inner diameter of lid and outer diameter of annular wall generally complement each other.

Preferably included on inner surface of lid wall, and disposed on a peripheral lower end, is a protrusion 245. Protrusion is configured to engage with a corresponding notch 244 on outer surface of upper insert annular wall and thus forms an interlocking mechanism for locking the lid when in a correct closing position. In addition to the interlocking mechanism, a sealing ring 231 may be provided circumferentially at the inner surface of lid's sidewall which, in closed position of the lid, abuts on upper insert annular wall 232 and provides for a further sealing of insert and lid assembly. Preferably, rim of upper insert annular wall 232 is chamfered to ensure ease of lid closure.

Upper insert annular wall 232 is arranged to snugly fit inside wall of lid to provide a sealing fit. When lid is in closed, sealing position, peripheral lower end of lid wall abuts upper surface of outwardly projecting flange. It is important to note in the current embodiment, that the lid is sealed with the insert and does not rely on features of the container body to provide a seal.

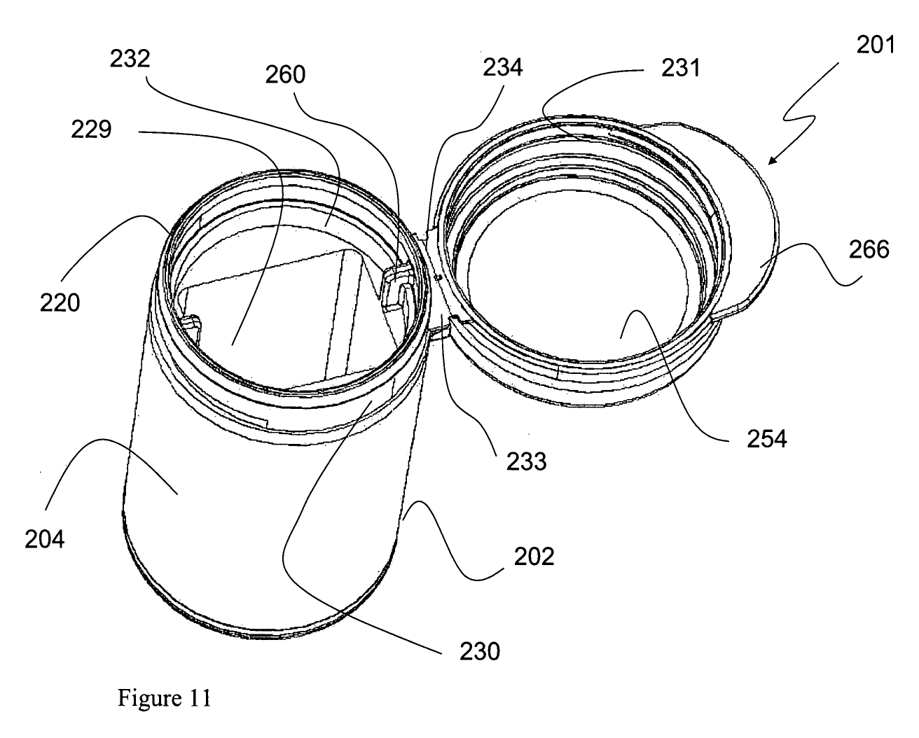

FIG. 11 shows a perspective view of the insert 220 according to FIG. 10 disposed in a container body 202 with lid 250 in an open position. Insert 220 is held in position by means of an interference fit between lower insert annular wall 232 and opening of container body 202 since outer diameter of lower insert annular wall and inner diameter of container opening are of the same order. In particular, raised profile of lower annular insert wall 232 ensures an interference fit between lower insert annular wall 232 and container body 202. Once insert 220 is fully inserted into its correct position, outer surface 230a of upper insert annular wall 230 forms a semi-contiguous surface with outer surface of container body 202 with rim of container body open end abutting upper insert annular wall 230. Furthermore, when lid is in a closed sealing position (not shown) rim of lid wall abuts rim of container open end.

Further shown in the current figure is the semi-contiguous surface between outer surface of container body 202 and outer surface of insert upper annular wall 230. Such semi-contiguous region is defined by equal diametrical outer diameter of both cylinder housing and insert upper annular wall 230. It has to be noted, that in the embodiment according to FIGS. 10 and 11, the container body does not provide a discontinuous region (14, see FIG. 2) of container wall, because, as mentioned above, lid is sealed with the insert and does not rely on features of the container body to provide a seal.

Upstanding protrusion 260 forming part of inner surface of lower and upper annular insert walls 230, 232 aid in the orderly containment of the test elements within the channel. Furthermore, such protrusion 260 reduces the likelihood of edges of individual test elements becoming trapped in the rim of the lid wall during closure thereof. For the purposes of clarity, the container is empty i.e. does not contain any test elements therein.

As is shown in the current view, lid 250 forms part of lower annular wall of insert 220 by means of a hinge 234 extending from outwardly projecting flange 233 projecting from lower annular wall 232 of insert. Arranged opposite the hinge 234 is lid tab 266, which, as previously mentioned, aids the user in opening and closing of vial lid for subsequent removal of test element for example. As mentioned previously, a sealing ring 231, positioned circumferentially at the inner surface of lid's sidewall, provides for a sealing of insert and lid assembly when lid is in a closed position.

Although not shown in the current figure, a cavity is created between inner wall surface of container wall and outer surface of insert wall for the containment of a desiccant material. In one embodiment of the inventive container, the cavity is provided at the bottom area of container body between the inner surface of container bottom and a bottom arranged at the lower end of insert wall. As described previously, the cavity may however be provided elsewhere about container according to different embodiments of the present invention. Cavity is for the containment of desiccant material which absorbs moisture which may ingress into container body and in particular rectangular channel during normal use of the container.

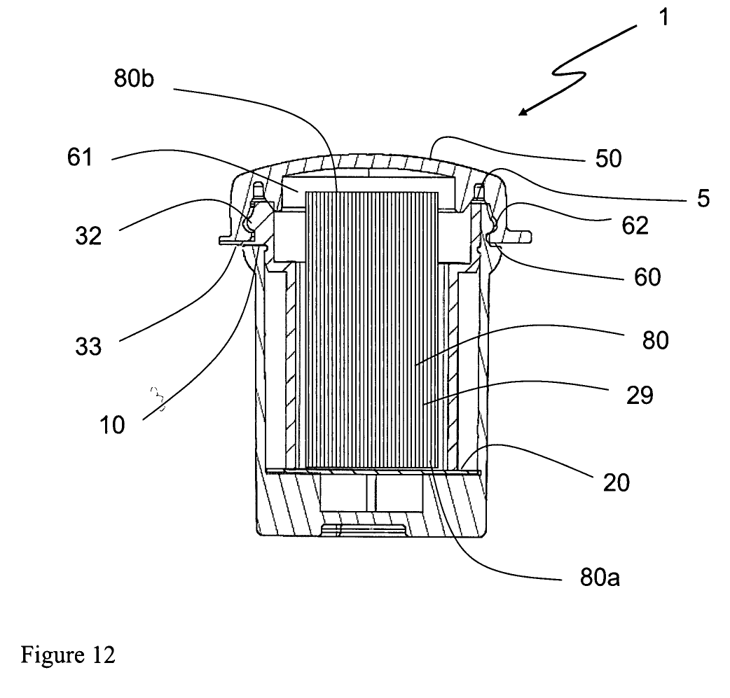

FIG. 12 shows a simplified cross-sectional view along line A-A′ of FIG. 1 with a stack of test elements contained within a container 1. Lid 50 is shown in a closed, sealing position.

As mentioned, in all embodiments of the invention, centrically arranged rectangular channel 29 of insert is dimensioned to guide disposed stack of test elements 80. Accommodated test elements 80 are oriented in an upright formation, that is, minor end 80a of test element(s) is arranged to perpendicularly abut first surface of bottom or false bottom 20 of insert. Furthermore, one minor end 80b of test elements 80, as shown, projects above rectangular insert channel 29 extending into hollow portion 61 of lid 50.

When lid is in a closed sealing position, it is shown that in the embodiment as shown in FIG. 12 which corresponds to the embodiments of FIG. 4 and FIG. 8, lid rim 60 abuts container body counterface 10 and projecting flange 33. Such closing arrangement further ensures that lid recess 62 is arranged to fit and interlock into ridge 32 of annular wall of insert 22 and of retaining element 131, respectively.

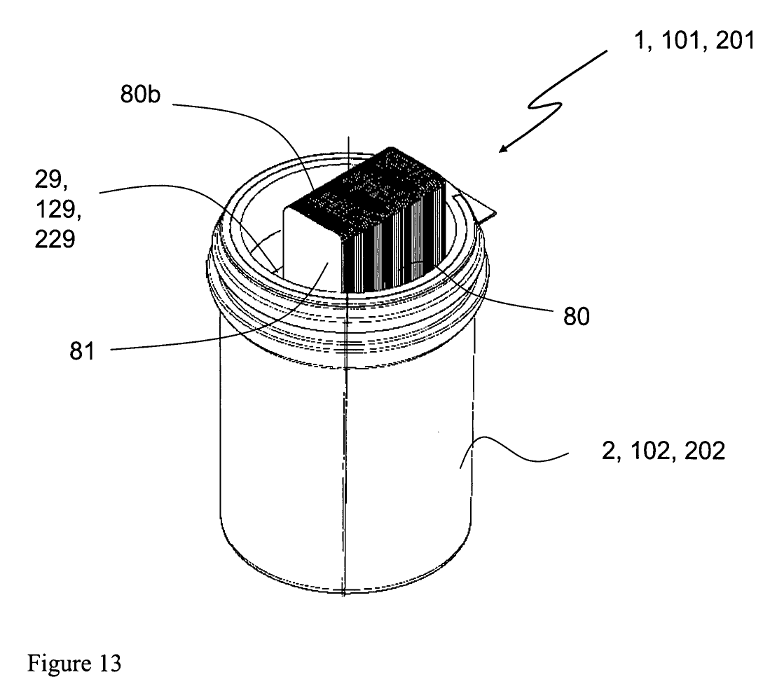

FIG. 13 shows a simplified perspective view depicting a stack of elements 80 inserted in the container 1, 101, 201 according to embodiments of the present invention.

Test elements 80 have first and second opposing minor ends 80a (not shown) and 80b with a length therebetween of about 40 mm. Width of test element may be about 13 mm. Other such dimensions can be used, as those skilled in the art will appreciate.

Stack of test elements 80 is inserted in rectangular insert channel 29, 129, 229, respectively, in such a manner that each test element minor end 80a perpendicularly abuts first surface of insert bottom or false bottom as mentioned. Occurrence of such abutment is such that a portion of second minor end 80b of test elements 80 projects above rectangular insert channel 29, 129, 229, respectively. That portion of test element 80 projecting above rectangular insert channel provides the interface surface 81 for allowing easy accessibility and handling of individual test elements 80 by a user. Dimension of interface surface 81 is about 7 mm, although persons skilled in the art will appreciate that such dimensions are variable.

Channel 29, 129, 229, respectively, may comprise a predetermined number of test elements 80, as shown. For example, stack may comprise twenty five test elements 80. However, the channel is not limited to accommodate a stack of twenty five test elements and may accommodate any suitable number of test elements. Indeed it would be obvious to persons skilled in the art that length and width of channel may be suitably dimensioned for test elements other than those described herein.

Once apprised of the present disclosure, one skilled in the art will recognise that container shape can take a variety of forms. For example, the shape of the container body may be similar to that of an ellipse so that the body of the container is considerably narrower in one direction than in the other. To maintain good sealing properties of lid against a counterface however, container opening and lid would preferably be circular.

Operational Sequence

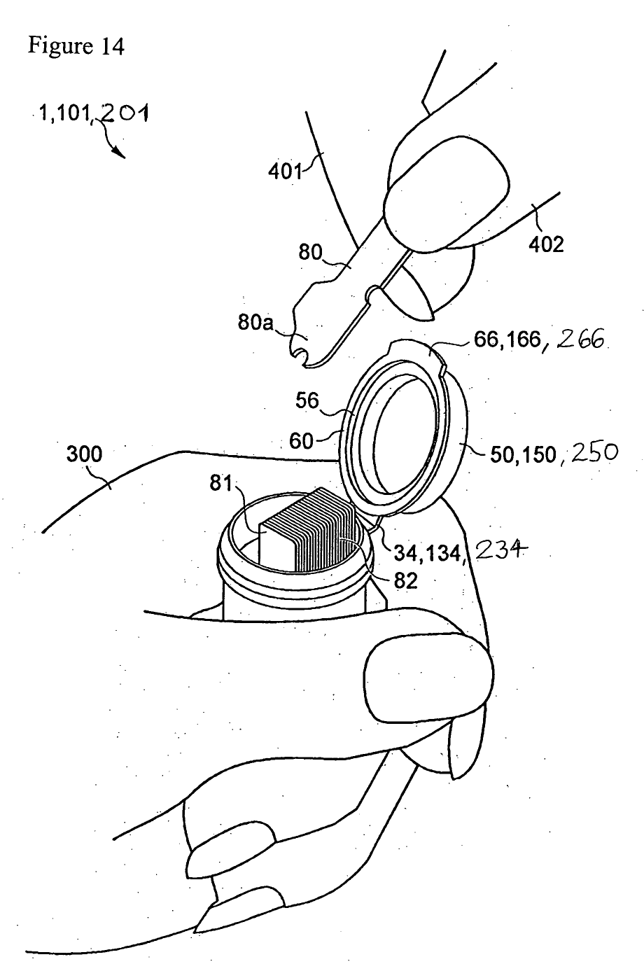

The use and operation of the container will now be described with reference to the previously discussed figures and with reference to FIG. 14 which depicts a simple perspective view of a container 1, 101, 201 grasped in a user's hand 300. Lid 50, 150, 250 is an open position exposing a stack of test elements 80 disposed therein with an individual test element 80 removed therefrom.

The lid opening process is initiated by lifting upwardly upon lid tab 66, 166, 266 which projects beyond container wall. The lifting force may be manipulated by a user's thumb of the grasping hand 300. Hinge 34, 134, 234 then provides for a selected displacement of the lid 50, 150, 250 from its closed sealing position.

As lid 50, 150, 250 is displaced to a fully extended position, stack of test elements 82 disposed within insert channel (29, 129, 229) is exposed. Preferably, user may grasp interface surface 81 of an individual test element 80 and upwardly remove test element from its abutted position, utilising index finger 401 and thumb 402 of non-grasping hand. Removal of individual test element 80 from container 1, 101, 201 allows subsequent use thereof.

In an opposite movement, lid 50, 150, 250 is closed by applying pressure thereto to force skirt (58, 158, see FIG. 5) completely within opening of insert. Again, the closing force may be manipulated by a user's thumb of the grasping hand. Skirt (58, 158) fits into opening of insert to seal the contents of the container. As lid 50, 150, 250 passes from an open position, tapered end of skirt (58, 158) passes over rim of container open end and continues until annular recess (62) of lid interlocks with ridge (32, 132) of insert wall, and, in the embodiments according to FIGS. 4 and 8, with semi-continuous collar (12, 112) of container wall. Such interlocking arrangement between recess (62) and ridge (32, 132) provides an audible ‘click’ ensuring user awareness of correct closure of lid.

Optionally, skirt (58, 158) and inner surface of insert annular wall (24b, 124b) may be constructed so that as lid 50, 150, 250 is moved to a closing position, lower end of the skirt (58, 158) may abut first end of insert (22) or first end of retaining element (131), that is to say the length of skirt (58, 158) depending from second surface of planar disk (54) may be constructed to be the same length as the inner face of insert annular wall (30). Such an arrangement may provide a further barrier against harmful environmental conditions.

As mentioned above, the interlocking mechanism of lid and insert can be of any nature providing a tight seal between insert and lid and, optionally, container body. As shown in the embodiments of FIGS. 10 and 11, the interlocking mechanism may be provided by a protrusion (245) engaging a corresponding notch (244). In this embodiment, a further sealing between lid and insert is achieved by a sealing ring (231) which is disposed circumferentially at the inner surface of lid's sidewall and, in closed position of the lid, abuts on insert upper annular wall (230).

Method of Manufacture of Container

Containers of the present invention may be manufactured in a number of different ways.

For example, container 1 according to the embodiment of the invention exemplary shown in FIG. 6 can be manufactured by moulding a container body 2 having a transparent wall 4 and having one closed end 6 and one open end. A desiccant material 18a, preferably containing a moisture indicator is inserted into a defined cavity 18 at the bottom 6 of the container body 2. A false bottom 20 is then introduced through container body 2 open end to retain disposed desiccant material 18a. Furthermore, an insert 22, preferably being opaque, is co-moulded with a lid 5 forming a one part piece. Insert 22 is moved into container body 2 through open end such that it forms an interference fit or a close fit within container body 2. One end of insert 22 abuts false bottom 20.

According to another embodiment of the invention as exemplary shown in FIG. 7, container 101 might be manufactured from a transparent material such that container body 102 has a transparent wall 104 and a closed end 106 and an open end. Optionally, an insert 122 is moulded or co-moulded with container body 102 having an outer diameter less than inner diameter of container body 102, thus defining a circumferential annular space 118. Optionally, insert 122 is introduced into container body 102 after container body is moulded. Desiccant material 118a which preferably contains a moisture indicator is introduced into circumferential annular space 118. A generally opaque retaining element 131 is co-moulded with a lid 150 forming a one part piece and is then inserted into container body 102 through open end thereof such that it forms an interference fit or close fit within container body 102.

As mentioned above, in a further embodiment the container may comprise cavities 18, 118 for the containment of desiccant material 18a, 118a in the cavity 18 formed in the bottom 6 area of the container body 2, 102 as well as in the circumferential annular space 118 between container body wall 4, 104 and insert wall 24, 124. In such a case, container can be manufactured by moulding a container body 2, 102, inserting the desiccant material 18a, preferably containing a moisture indicator, into a defined cavity 18 at the bottom 6 of the container body, introducing false bottom 20 through container body open end to retain desiccant material 18a disposed at the bottom 6 of container body, inserting insert 22, 122 in container body 2, 102, inserting desiccant material 118a, optionally containing a moisture indicator, into circumferential annular space 118 formed between container body 2, 102 and insert 22, 122, inserting a retaining element 131 co-moulded with the lid 150.

Various embodiments of the invention have been described above. The descriptions are intended to be illustrative, not limitative. Thus, it will be apparent to one skilled in the art that certain modifications may be made to the invention as described without departing from the scope of the claims set out below.

1. A container for moisture sensitive test elements comprising a container body (2, 102, 202) comprising a closed bottom (6, 106) and an open end, an insert (22, 122, 220) fitting in container body (2, 102, 202), whereby a cavity (18, 118) is formed between outer surface (24a, 124a) of insert wall (24, 124, 240) and inner surface (4b, 104b) of container body wall (4, 104, 204), and a lid (50, 150, 250) dimensioned to seal container open end when in a closed position, wherein a desiccant material is contained within cavity (18, 118) between inner surface of container body wall and outer surface of insert wall.

2. A container according to claim 1, wherein the lid (50, 250) is integrally connected to the insert (22, 220).

3. A container according to claim 1, wherein the lid (150) is integrally connected to a retaining element (131), which fits in the open end of container body (2).

4. A container according to claim 1, wherein the walls (24, 124, 240) of insert (22, 122, 220) form a rectangular longitudinal hollow channel (29, 129, 229) dimensioned to contain a stack of test elements.

5. A container according to claim 4, wherein length of hollow channel (29, 129, 229) is dimensioned to be less than length of test element so that at least one test element contained therein extends above insert wall (24, 124, 240) into lid hollow portion (61, 161) when lid is in a closed sealing position.

6. A container according to claim 1, wherein a cavity (18) for containment of the desiccant material is formed between the bottom wall (6) of container body (2, 202) and the bottom (20) of insert (22, 220).

7. A container according to claim 6, wherein the bottom (20) of insert (22, 220) is of a porous material and/or moisture permeable material.

8. A container according to claim 1, wherein a circumferential annular space (118) is formed between outer surface of insert wall (124a) and inner surface of container wall (104b) for containment of the desiccant material.

9. A container according to claim 8, wherein the walls (24) of insert (22) are of a porous material and/or moisture permeable material.

10. A container according to claim 1, wherein the desiccant material contains an indicator whose colour changes when exposed to moisture.

11. A container according to claim 1, wherein the container body (2, 102 202) has a transparent wall and/or wall section.

12. A container according to claim 1, wherein the insert (22, 122, 220) is opaque.

13. A method of manufacturing a container according to claim 1 comprising the steps of:
(i) moulding a container body (2, 202) with integral walls (4, 204) and bottom (6);
(ii) co-moulding insert (22, 220) and lid (50, 250);
(iii) inserting desiccant material in a cavity (18, 118) between inner surface of container body wall and outer surface of insert wall; and
(iv) assembling container body (2, 202) and insert (22, 220); and/or
(i) co-moulding container body (102) and insert (122);
(ii) co-moulding retaining element (131) and lid (150);
(iii) inserting desiccant material in a cavity (18, 118) between inner surface of container body wall and outer surface of insert wall; and
(iv) assembling container body (102) including insert (122) and retaining element (131) with co-moulded lid (150).
